(19) United States
(12) Patent Application Publication
(10) Pub. No.: US 2026/0154181 A1
(43) Pub. Date: Jun. 4, 2026

(54) METHOD AND SYSTEM TO PERFORM VALIDATION OF PULL REQUESTS

(71) Applicant: JPMorgan Chase Bank, N.A., New York, NY (US)

(72) Inventor: Shashank KADNE, Mumbai (IN)

(73) Assignee: JPMorgan Chase Bank, N.A., New York, NY (US)

(21) Appl. No.: 19/406,422

(22) Filed: Dec. 2, 2025

(30) Foreign Application Priority Data
Dec. 4, 2024 (IN) 202411095644

(51) Int. Cl. G06F 11/3668

(52) U.S. Cl. CPC G06F 11/3672

(57) ABSTRACT

A method and system for performing validation of pull requests are disclosed. The method includes receiving a pull request from a user and transmitting the pull request into a queue. The method further includes retrieving, from the queue, a payload associated with the pull request. The method further includes extracting a pull request identifier and a task description identifier from the payload. The method further includes obtaining code commit details using the pull request identifier and obtaining a task description using the task description identifier. The method further includes generating, for a trained model, a prompt using the code commit details and the task description. The method further includes processing, using the trained model, the prompt to provide validation feedback for the pull request to the user.

### CROSS-REFERENCE TO RELATED APPLICATIONS

This application claims priority benefit from Indian Application No. 202411095644, filed on Dec. 4, 2024, in the India Patent Office, which is hereby incorporated by reference in its entirety.

### FIELD OF THE DISCLOSURE

The present invention generally relates to software development and project management, and more particularly relates to a method and system to perform validation of pull requests by validating code commits against project management criteria.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With advancement in technology, various industries have been adopting automation by using various software. In the evolving landscape of software applications and deployment, effective management of application modification and installation processes is crucial for optimizing operational efficiency. In modern software development, managing code quality and ensuring alignment with project management criteria are critical aspects of successful project delivery.

Traditional methods of enforcing project management criteria include manual review processes, code inspections, and adherence to established guidelines. However, these methods are often labor-intensive, prone to human error, and may lack real-time enforcement capabilities.

Currently, software development teams face significant challenges in maintaining proper documentation and alignment between code commits or code changes and project management tools (e.g., JIRA®). For example, reviewers may be required to manually cross-reference JIRA® descriptions with code changes, because of which average review time increases by 30-40% due to validation requirements. Further, any human error in the review process may lead to missed requirements or scope creep. Additionally, code commits by software developers often contain changes unrelated to the reference's JIRA^{®}ticket, thereby it becomes difficult to audit which requirements were actually implemented, and therefore compliance and regulatory reporting also become challenging. These challenges may result in poor traceability, inconsistent documentation, increased review burden and a higher risk of misalignment between project requirements and the code changes. Current manual processes are time consuming and error prone, thereby leading to inefficiencies. The shortcomings of existing methods underscore the need for an innovative approach for faster and efficient validation process for code commits.

Moreover, JIRA® descriptions are often vague, incomplete or outdated, and there is no automated mechanism to ensure requirements are testable and complete. This forces software developers to proceed with ambiguous requirements, leading to rework.

Hence, in view of these and other existing limitations, there arises an imperative need to provide an efficient solution to overcome the above-mentioned limitations and to provide a method and system to deliver automation of the validation process for code commits.

### SUMMARY

The present disclosure, through one or more of its various aspects, embodiments, and/or specific features or sub-components, provides, inter alias, various systems, servers, devices, methods, media, programs, and platforms to perform validation of pull requests.

According to an aspect of the present disclosure, a method for performing validation of pull requests is disclosed. The method is implemented by at least one processor. The method includes receiving a pull request from a user; transmitting the pull request into a queue; retrieving, from the queue, a payload associated with the pull request; extracting a pull request identifier and a task description identifier from the payload; obtaining code commit details using the pull request identifier, and obtaining a task description using the task description identifier; generating, for a trained model, a prompt using the code commit details and the task description; and processing, using the trained model, the prompt to provide a validation feedback for the pull request to the user.

In accordance with an exemplary embodiment, the code commit details may include code modifications made to code files and metadata associated with the modified code files.

In accordance with an exemplary embodiment, the task description may include at least one test scenario and a predefined acceptance criterion for at least one from among a project and an issue.

In accordance with an exemplary embodiment, the prompt may be generated using at least one predefined prompt template.

In accordance with an exemplary embodiment, the trained model may be configured using a large language model (LLM).

In accordance with an exemplary embodiment, the validation feedback may include one from among: an approval of the pull request together with a positive comment and a rejection of the pull request together with at least one suggestion.

According to another aspect of the present disclosure, a computing device configured to implement an execution of a method for performing validation of pull requests is disclosed. The computing device may include a processor, a memory storing instructions, and a communication interface coupled to each of the processor and the memory. The processor may be programmed to cooperate with the instructions to perform operations including: receiving a pull request from a user; transmitting the pull request into a queue; retrieving, from the queue, a payload associated with the pull request; extracting a pull request identifier and a task description identifier from the payload; obtaining code commit details using the pull request identifier, and obtaining a task description using the task description identifier; generating, for a trained model, a prompt using the code commit details and the task description; and processing, using the trained model, the prompt to provide a validation feedback for the pull request to the user.

In accordance with an exemplary embodiment, the code commit details may include code modifications made to code files and metadata associated with the modified code files.

In accordance with an exemplary embodiment, the task description may include at least one test scenario and a predefined acceptance criterion for at least one from among a project and an issue.

In accordance with an exemplary embodiment, the prompt may be generated using at least one predefined prompt template.

In accordance with an exemplary embodiment, the trained model may be configured using a large language model (LLM).

In accordance with an exemplary embodiment, the validation feedback may include one from among: an approval of the pull request together with a positive comment and a rejection of the pull request together with at least one suggestion.

According to yet another aspect of the present disclosure, a non-transitory computer-readable storage medium storing instructions for performing validation of pull requests is disclosed. The instructions include executable code which, when executed by a processor, may cause the processor to perform operations including: receiving a pull request from a user; transmitting the pull request into a queue; retrieving, from the queue, a payload associated with the pull request; extracting a pull request identifier and a task description identifier from the payload; obtaining code commit details using the pull request identifier, and obtaining a task description using the task description identifier; generating, for a trained model, a prompt using the code commit details and the task description; and processing, using the trained model, the prompt to provide a validation feedback for the pull request to the user.

In accordance with an exemplary embodiment, the code commit details may include code modifications made to code files and metadata associated with the modified code files.

In accordance with an exemplary embodiment, the task description may include at least one test scenario and a predefined acceptance criterion for at least one from among a project and an issue.

In accordance with an exemplary embodiment, the prompt may be generated using at least one predefined prompt template.

In accordance with an exemplary embodiment, the trained model may be configured using a large language model (LLM).

In accordance with an exemplary embodiment, the validation feedback may include one from among: an approval of the pull request together with a positive comment and a rejection of the pull request together with at least one suggestion.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system for performing validation of pull requests, in accordance with an exemplary embodiment of the present disclosure.

FIG. 2 illustrates an exemplary diagram of a network environment for performing validation of pull requests, in accordance with an exemplary embodiment of the present disclosure.

FIG. 3 illustrates an exemplary system for performing validation of pull requests, in accordance with an exemplary embodiment of the present disclosure.

FIG. 4 illustrates an exemplary method flow diagram for performing validation of pull requests, in accordance with an exemplary embodiment of the present disclosure.

FIG. 5 illustrates a flow chart depicting a process of performing validation of a pull request, in accordance with an exemplary embodiment of the present disclosure.

FIG. 6 illustrates a block diagram of a system for performing validation of pull requests, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections, and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Currently, there is a notable absence of systems or products or methods that can offer automation of the validation process for code commits in order to perform efficient project management. Currently, software development teams face significant challenges in maintaining proper documentation and alignment between code commits and project management tools. These challenges may result in poor traceability, inconsistent documentation, increased review burden and a higher risk of misalignment between project requirements and code changes. Also, validation of the code commits though manual processes are time consuming and error prone, thereby leading to inefficiencies.

The present disclosure solves aforementioned problems by providing a method and system to perform validation of pull requests. In the present disclosure, at first, the system receives a pull request from a user. Further, the system transmits the pull request into a queue. Further, the system retrieves, from the queue, a payload associated with the pull request. Further, the system extracts a pull request identifier and a task description identifier from the payload. Further, the system obtains code commit details using the pull request identifier, and the system obtains a task description using the task description identifier. Further, the system generates, for a trained model, a prompt using the code commit details and the task description. Thereafter, the system processes, using the trained model, the prompt to provide validation feedback for the pull request to the user.

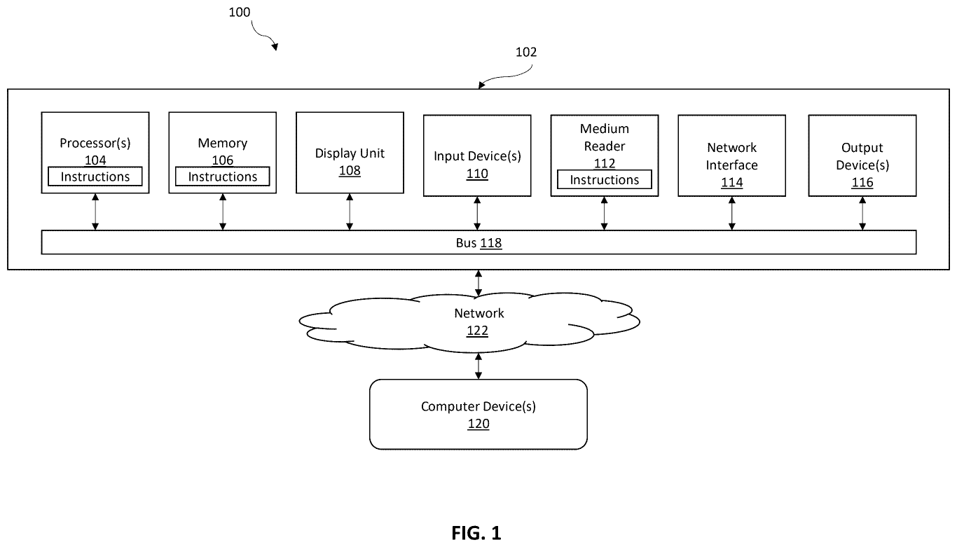

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication with each other. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are of an article about manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, and/or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, and/or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, and/or any combination thereof. Additionally, the term “Network interface” may also be referred to as “Communication interface” and such phrases/terms can be used interchangeably in the specification.

Each of the components of the computer system 102 may be interconnected and communicate via a bus 118 or other communication link. As shown in FIG. 1, the components may be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, and/or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, and/or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for performing validation of pull requests.

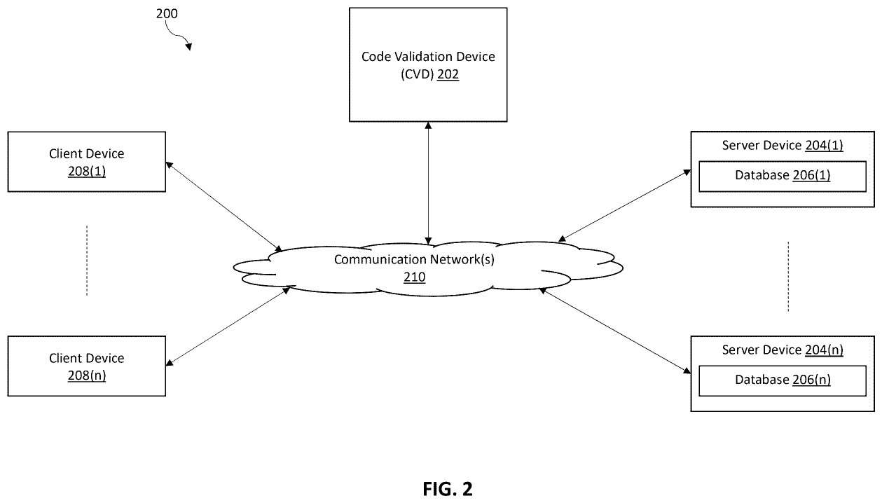

Referring to FIG. 2, a schematic of an exemplary network environment 200 for executing a method for performing validation of pull requests is illustrated. In an exemplary embodiment, the method is executable on any networked computer platform, such as, for example, a personal computer (PC).

The method for performing validation of pull requests may be executed by a code validation device (CVD) 202. The CVD 202 may be the same or similar to the computer system 102 as described with respect to FIG. 1. The CVD 202 may store one or more applications that may include executable instructions that, when executed by the CVD 202, cause the CVD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the CVD 202 itself, may be located in the virtual server(s) running in a cloud-based computing environment rather than being tied to one or more specific physical network computing devices. Also, the application(s) may be running in one or more virtual machines (VMs) executing on the CVD 202. Additionally, in one or more embodiments of this technology, virtual machine(s) running on the CVD 202 may be managed or supervised by a hypervisor.

In the network environment 200 of FIG. 2, the CVD 202 is coupled to a plurality of server devices 204(1)-204(n) that hosts a plurality of databases 206(1)-206(n), and also to a plurality of client devices 208(1)-208(n) via communication network(s) 210. A communication interface of the CVD 202, such as the network interface 114 of the computer system 102 of FIG. 1, operatively couples and communicates between the CVD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CVD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and CVDs that efficiently implement the method for performing validation of pull requests.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The CVD 202 may be a standalone device or integrated with one or more other devices or apparatuses, such as one or more of the server devices 204(1)-204(n), for example. In one particular example, the CVD 202 may include or be hosted by one of the server devices 204(1)-204(n), and other arrangements are also possible. Moreover, one or more of the devices of the CVD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the CVD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data related to at least one pull request, task descriptions, and/or a payload associated with the at least one pull request.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment, and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CVD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the CVD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the CVD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CVD 202, the server devices 204(1)-204(n), or the client devices 208(1)-208(n), for example, may be configured to operate as virtual instances on the same physical machine. In other words, one or more of the CVD 202, the server devices 204(1)-204(n), or the client devices 208(1)-208(n) may operate on the same physical device rather than as separate devices communicating through communication network(s) 210. Additionally, there may be more or fewer CVDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

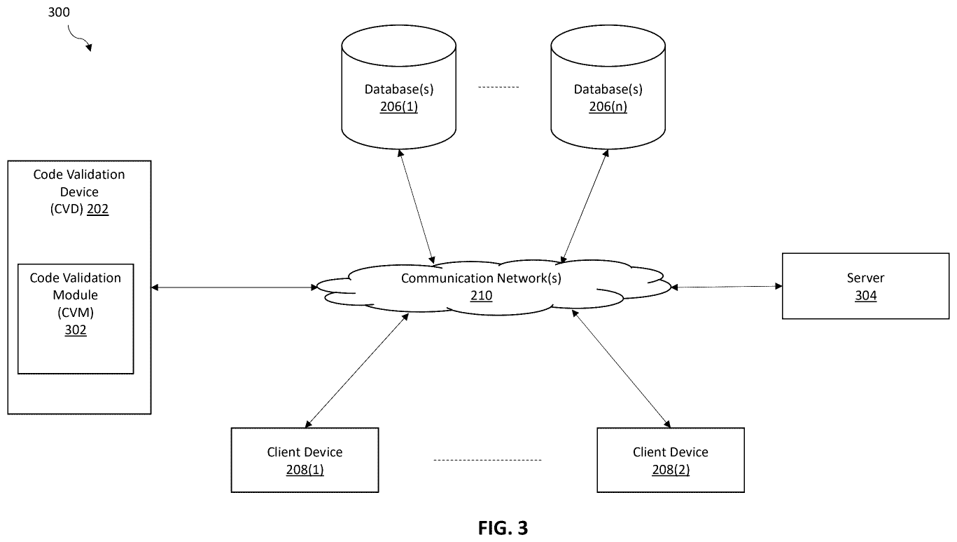

FIG. 3 illustrates a system diagram for implementing a method for performing validation of pull requests, in accordance with an exemplary embodiment.

As illustrated in FIG. 3, the system 300 may include a code validation device (CVD) 202 within which a code validation module (CVM) 302 is embedded, a server 304, a database(s) 206(1)...206(n), a plurality of client devices 208(1) . . . 208(2), and a communication network(s) 210.

According to exemplary embodiments, the CVD 202 including the CVM 302 may be connected to the server 304, and the database(s) 206(1) . . . 206(n) via the communication network(s) 210, but the disclosure is not limited thereto. The CVD 202 may also be connected to the plurality of client devices 208(1) . . . 208(2) via the communication network 210, but the disclosure is not limited thereto. The database(s) 206(1) . . . 206(n) may include a rule database.

In an embodiment, the CVD 202 is described and shown in FIG. 3 as including the CVM 302, although it may include other rules, policies, modules, databases, or applications, for example. As will be described below, the CVM 302 is configured to implement a method for performing validation of pull requests.

An exemplary system 300 for implementing a mechanism to perform validation of pull requests by utilizing the network environment of FIG. 2 is shown as being executed in FIG. 3. Specifically, a first client device 208(1) and a second client device 208(2) are illustrated as being in communication with the CVD 202. In this regard, the first client device 208(1) and the second client device 208(2) may be “clients” of the CVD 202 and are described herein as such. Nevertheless, it is to be known and understood that the first client device 208(1) and/or the second client device 208(2) need not necessarily be “clients” of the CVD 202, or any entity described in association therewith herein. Any additional or alternative relationship may exist between either or both of the first client device 208(1) and the second client device 208(2) and the CVD 202, or no relationship may exist.

Further, the CVD 202 is illustrated as being able to access one or more databases 206(1) . . . 206(n). The CVM 302 may be configured to access these repositories/databases for implementing a method for performing validation of pull requests. In some embodiment, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the CVD 202 via broadband or cellular communication. These embodiments are merely exemplary and are not limiting or exhaustive.

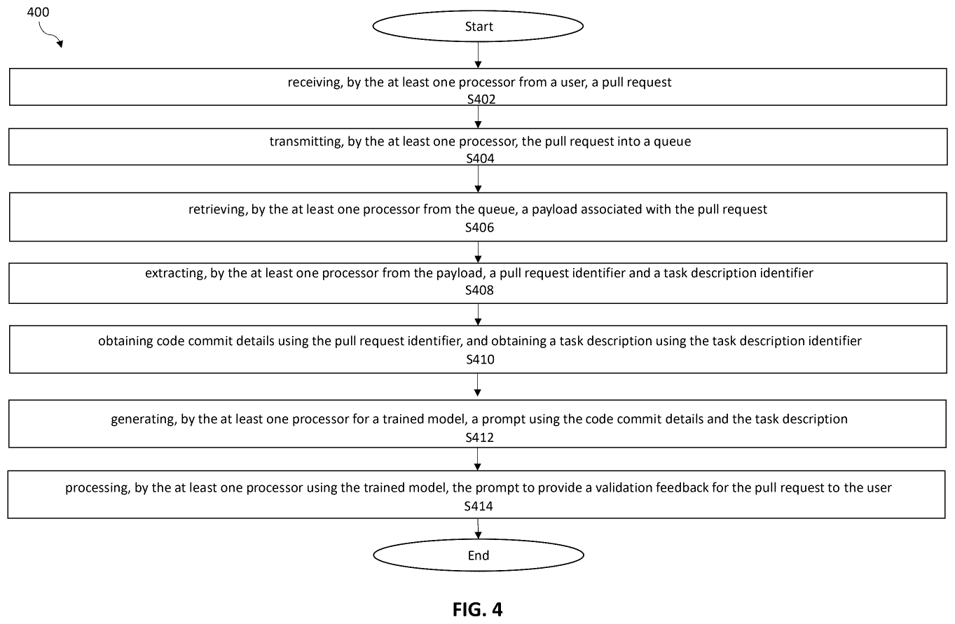

Referring to FIG. 4, an exemplary method 400 for performing validation of pull requests is illustrated, in accordance with an exemplary implementation.

As shown in FIG. 4, the method 400 begins following a need for performing validation of code commits provided by a developer via a pull request against a predefined project management criterion. The method 400 is implemented by at least one processor 104.

At step S402, the method 400 includes receiving, by the at least one processor 104 from a user, a pull request. The user may be a developer.

The term “pull request” herein may correspond to a mechanism used in software development for proposing and managing changes to a source code repository. It involves a developer creating a request to merge a set of modifications from a separate branch into the primary branch of the source code repository.

In an example, the developer raises the pull request to bring a new feature to a code repository and/or to perform at least one task with respect to the code repository. The at least one task may include any one or more of implementing a new feature, fixing a bug, refactoring code, and updating documentation. The pull request may include information about branch merging, a repository, and/or a formal request that the proposed changes be reviewed and integrated into a main branch.

In an example, the user may raise the pull request by using a user interface (UI) of an application installed in a user equipment (UE). The UE may be selected from, but is not limited to, a smartphone, a laptop, a tablet, and a computer.

It would be appreciated by the person skilled in the art that the aim here is to create a system that performs validation of pull requests.

At step S404, the method includes transmitting, by the at least one processor 104, the pull request into a queue. If the pull request is for a development branch, then the at least one processor 104 puts the pull request into the queue (e.g., a simple queue service (SQS)) for further processing of the pull request. It is to be noted that the queue is used to avoid possible overload on the processing unit for processing multiple pull requests at a time.

In an exemplary implementation, the method includes fetching, by the at least one processor 104, the pull request from at least one queue belonging to an organization. The queue may be connected with the at least one processor 104 via a communication network. The communication network may be an Internet-based network.

At step S406, the method includes retrieving, by the at least one processor 104 from the queue, a payload associated with the pull request.

The term “payload” herein may refer to a document or an information transmitted in the pull request, which may include details about the proposed changes and associated metadata. The payload may include any one or more of details of an event that triggered the pull request (e.g., pull request opened, pull request updated, etc.), details of an author who created the pull request, details of a source branch and a target branch involved in the pull request, a textual description and/or a summary provided by the author of the pull request, a pull request unique identifier (ID), and/or a title of the pull request that has a task description number (e.g., a JIRA® ID) and a status (e.g., an open, closed, or merged).

At step S408, the method includes extracting, by the at least one processor 104 from the payload, a pull request identifier and a task description identifier.

In an exemplary implementation, the method includes analyzing, by the at least one processor 104, the payload to extract the pull request identifier for the pull request and a task description identifier for the task description. A pull request identifier and the task description identifier refer to a distinct alphanumeric code or number assigned to uniquely identify the pull request and the task description respectively.

At step S410, the method includes obtaining, by the at least one processor 104, code commit details (also referred to as code commits) using the pull request identifier, and obtaining a task description using the task description identifier.

The code commit details may include code modifications made to code files and metadata associated with the modified code files. In a non-limiting implementation, the metadata associated with the modified code files may include any one or more of author information, code modification date and time, version history, file size, and/or name(s) of the modified code files. In an example, the code commits details may include the names of the files modified and the changes done to those files, including code that was added, code that was removed, and some additional existing code for context. The task description may include a predefined acceptance criterion for at least one project and at least one test scenario.

In an exemplary implementation, the method includes obtaining, by the at least one processor 104 via a first application programming interface (API), from a server of a first platform (e.g., Bitbucket®), the code commits details using the pull request identifier. The method further includes obtaining, by the at least one processor 104 via a second API, from a server of a second platform (JIRA®), the task description using the task description identifier. As used herein, API refers to a set of rules and protocols that allow different software applications to communicate with each other.

At step S412, the method includes generating, by the at least one processor 104 for a trained model, a prompt using the code commit details and the task description. The code commit details may include code modifications made to code files and metadata associated with the modified code files.

The prompt may be generated using at least one predefined prompt template. The trained model may be configured using a large language model (LLM). In an exemplary implementation, the LLM is selected from but not limited to, GPT 3.5 Turbo, GPT 4, and Codellama. The prompt is generated for the LLM model that is trained on code and fine-tuned for instructions. A large language model (LLM) is an advanced machine learning model that processes and generates human language based on extensive training data.

At step S414, the method includes processing, by the at least one processor 104 using the trained model, the prompt to provide a validation feedback for the pull request to the user. The validation feedback includes one from among an approval of the pull request together with a positive comment and a rejection of the pull request together with at least one suggestion.

The pull request gets approved when the code commit details align with the task description. The positive comment states that the code commit details align with the task description. The pull request gets rejected when the code commit details fail to align with the task description and hence are unable to fit a project management criterion. The at least one suggestion may include a recommendation for the changes in the code commit details to the user. Further, in an event, a platform (e.g., JIRA®) has conflicting or unclear instructions for task descriptions, then a feedback is provided to the platform to review and update the task descriptions.

An example of the validation feedback is provided as follows: {“action”: “approve”, “comment”: “The code commits to align with the Jira® ticket's acceptance criteria. The hardcoded bank information is correctly implemented for the French language, and the current year is dynamically inserted into the text. The formatting rule SHOW_HARDCODED_BANK_INFORMATION is also correctly added.”}. Thereafter, the method terminates.

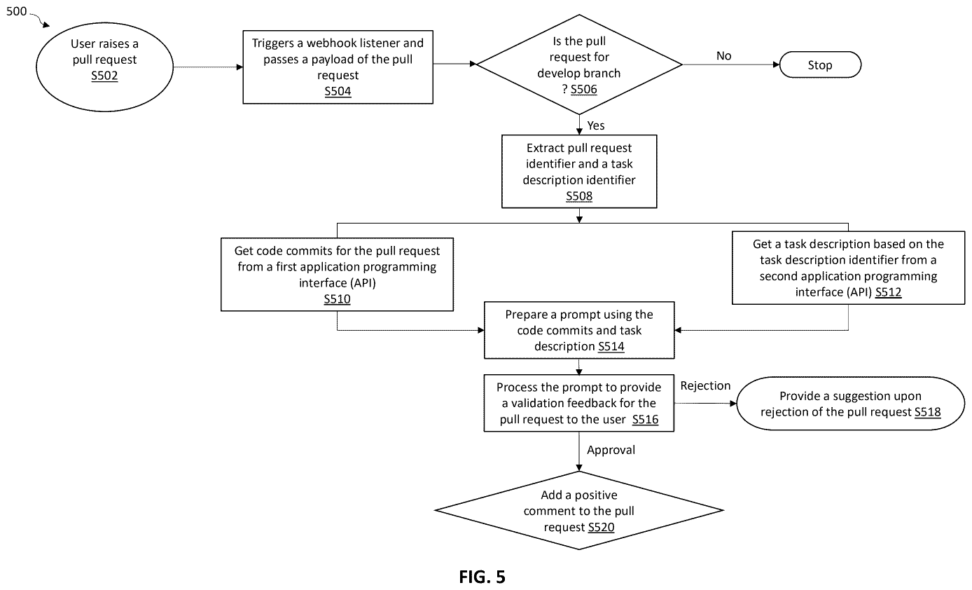

FIG. 5 illustrates a flow chart depicting a process for performing validation of a pull request, in accordance with an exemplary implementation of the present disclosure. As illustrated in FIG. 5, the process flow 500 begins at step S502 by receiving a pull request from a user or a developer. At step S504, the at least one processor 104 triggers a service (e.g., webhook listener) and passes the pull request along with its payload, for further processing. In an exemplary implementation, the webhook listener may be based on spring boot REST controller technology. The purpose of this service is to capture real-time events and filter these events to receive bitbucket webhook events for all pull request actions. The service may further filter the events targeting protected branches (develop/main) and publish validated events to Amazon Simple Queue Service (AWS SQS) for asynchronous processing. The webhook listener also provides immediate acknowledgment to bitbucket (<100 ms response time). The webhook listener may further perform deduplication to prevent duplicate processing, validates payload and performs sanitization and monitors health along with and metrics collection.

At step S506, the at least one processor 104 determines whether the pull request is for a develop branch. If not, then the process stops, else the pull request proceeds for further processing into a queue. At step S508, the at least one processor 104 extracts a pull request identifier (ID) and a task description identifier (ID). The pull request identifier and the task description identifier are extracted from the payload associated with the pull request. In an exemplary implementation, the processor 104 may be a commits processor. The commits processor may also be referred to as an orchestration engine.

At step S510, the at least one processor 104 gets code commit details using the pull request identifier from a first application programming interface (API) of a first platform (e.g., Bitbucket®). The code commit details may include code modifications made to code files and metadata associated with the modified code files. The first platform stores code commits details. In an exemplary implementation, the commits processor invokes bitbucket representational state transfer application programming interface (REST API) to retrieve all commit details for the pull request including differential information (e.g. files changed, additions/deletions).

At step S512, the at least one processor 104 gets a task description based on the task description identifier from a second application programming interface (API) of a second platform (e.g., JIRA®). The second platform includes task descriptions for various projects. In an exemplary implementation, the commits processor pulls request metadata (e.g. author, reviewers, status) and extracts JIRA® ticket IDs from PR description/title. The commits processor may also invoke JIRA® REST API to retrieve complete JIRA® description and acceptance criteria, user stories, bug reports, or task details and custom fields (e.g. priority, labels, components).

At step S514, the at least one processor 104 prepares a prompt using the code commit details and the task description. In an exemplary implementation, the commits processor may also be responsible for performing intelligent chunking and analyzing total code commit size using a large language model (LLM). If commits exceed an LLM context window (e.g., 32K tokens for GPT-4), then the commits processor splits commits by file or logical module and processes each chunk independently through the LLM. The commits processor may then aggregate partial validation results and generate final consolidated report via LLM synthesis.

At step S516, a trained model processes the prompt to provide a validation feedback for the pull request to the user. The validation feedback may include an approval of the pull request together with a positive comment (e.g., the code commits details aligned with the task description) at step S520, or a rejection of the pull request together with at least one suggestion (e.g., needs more work or corrections required in the pull request) at step S518. In an exemplary implementation, the validation process by the trained model may include any one or more of parsing a JIRA® description into discrete, testable requirements, mapping code changes to extracted requirements, identifying missing, incomplete, or incorrect implementations, flagging out-of-scope changes not related to JIRA®, and/or checking whether unit tests validate the requirements.

It will be appreciated by the person skilled in the art that the disclosed method offers a full-circle, adaptable, and intelligent solution for implementing a method for accelerating the validation of pull requests.

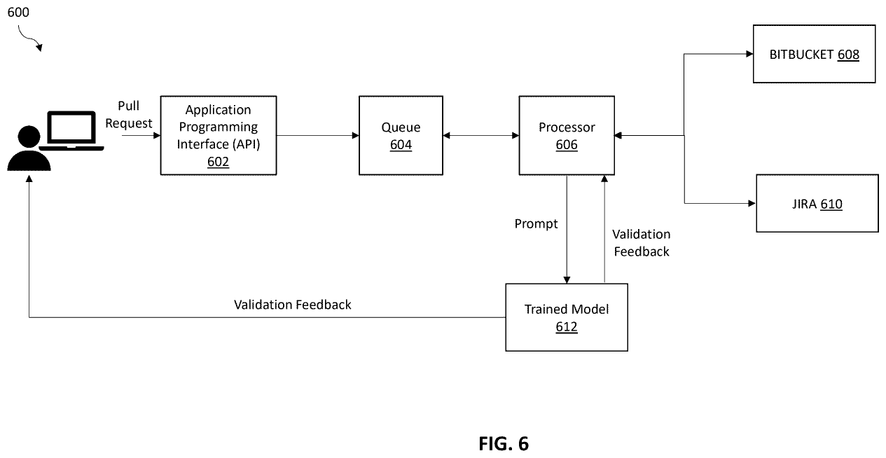

FIG. 6 illustrates a block diagram of a system for performing validation of pull requests, in accordance with an exemplary implementation of the present disclosure. As illustrated in FIG. 6, the process flow 600 begins with receiving a pull request from a user or a developer. The user may raise the pull request by using a computing device. The computing device may be selected from but is not limited to, a laptop, a smartphone, and a tablet.

Further, an application programming interface (API) 602 of a service (e.g., a webhook listener) gets triggered in response to the pull request in case the pull request is for the development branch. At first, the API 602 sends a payload associated with the pull request to a cloud-based service (e.g., elastic container service (ECS)). Further, the cloud-based service verifies the pull request and sends the verified pull request into a queue 604 (e.g., simple queue service (SQS) queue). Further, a processor 606 is used to pull details such as the payload from the queue 604 and to extract a pull request identifier (ID) and a task description identifier or number (e.g., JIRA® number) from the payload. Further, the processor 606 gets code commit details using the pull request identifier from a first application programming interface (API) of a first platform 608 (e.g., Bitbucket®). The code commit details may include code modifications made to code files and metadata associated with the modified code files. It is to be noted that the code commit details are stored in the first platform 608 such as the bitbucket®. The processor 606 gets a task description based on the task description identifier from a second application programming interface (API) of a second platform 610 (e.g., JIRA®). Furthermore, the processor 606 generates a prompt using the code commit details and the task description. The prompt may be generated using at least one predefined template. Further, the processor 606 transmits the prompt to a trained model (e.g., LLM model) 612 which processes the prompt to provide validation feedback to the user, in response to the pull request. The validation feedback may include an approval of the pull request together with a positive comment (e.g., the code commits details aligned with the task description) or a rejection of the pull request together with at least one suggestion (e.g., needs more work or corrections required in the pull request). The trained model 612 also transmits the validation feedback to the processor 606 which further updates the first platform 608 based on the validation feedback. This way the pull request gets validated against the project management criterion.

An exemplary use case of method 600 is illustrated below depicting how software development teams ensure code quality and requirement alignment leveraging cutting-edge LLM technology

### Exemplary Use Case

Consider the following JIRA® code asking to add a pop-up information text with a hardcoded statement and dynamic year. It is to be noted that the source code has been truncated at multiple lines for brevity.

JIRA®:

### Acceptance Criteria

Scenario 1—Update pop-up wording

Given I am on the Webpage

And the language is French

When I view the Overall Rating information pop-up text

Then I want to see the following text hard coded:

® YYYY Pour plus d'informations sur la méthodologie, veuillez consulter la page.

And YYYY should be replaced with the current year i.e. 2025 and this should change to 2026 in January

### Positive Scenario: Assuming Developer Correctly Makes All the Changes as Below.

### Commits:

summary_header.js
Added if (doesFormattingRulesContain(“SHOW_HARDCODED_INFORMATION”, this.props, [“formattingRu
   const disclosureText=StringUtility.getLocalizedString(this.props.intl, null, “pdp-summary-header-rating-text”,
      {year: new Date().getFullYear()});
   if (!isNil(disclosureText) && disclosureText !==‘pdp-summary-header-rating-text’)
{
   disclosure[tooltipId]=disclosureText;
   }
}
Datapoint.java
Added
formattingRules.add(FormattingRules.SHOW_HARDCODED_INFORMATION); translated_be_fr.json
Added
“pdp-summary-header-rating-text”: “® {year} Pour plus d'informations sur la méthodologie, veu

### Prompt (Truncated for Brevity)

“Review the below JIRA description of a feature followed by the code commits. Return a JSON response”

Output from LLM Module:
{
“summary”: {
“total_requirements”: 4,
“passed”: 4,
“failed”: 0,
“pass_rate”: “100%”
},
“comment”: [
{
“requirement_id”: “REQ-1”,
“requirement”: “Display hardcoded French text in Rating information pop-up”,
“source”: “Acceptance Criteria—When I view the Overall Rating information pop-up text
“result”: “pass”,
“comment”: “The implementation correctly adds the French translation string in ‘translated_be_fr
},
{
“requirement_id”: “REQ-2”,
“requirement”: “Replace YYYY placeholder with current year dynamically”,
“source”: “Acceptance Criteria—And YYYY should be replaced with the current year ie 2025”,
“result”: “pass”,
“comment”: “The code correctly implements dynamic year replacement using ‘new Date().getFullYear
},
{
“requirement_id”: “REQ-3”,
“requirement”: “Ensure year automatically updates to 2026 in January without code changes”,
“source”: “Acceptance Criteria—this should change to 2026 in January”, “result”: “pass”,
“comment”: “The implementation satisfies the automatic year update requirement by using ‘new Dat
},
{
“requirement_id”: “REQ-4”,
“requirement”: “Target French language specifically for the pop-up text”,
“source”: “Acceptance Criteria—And the language is French”,
“result”: “pass”,
“comment”: “The implementation correctly targets French language by adding the translation strin
}
]
}

### Negative Scenario: Assuming Developer Hardcodes the Year Instead of Making it Dynamic.

### Commits:

summary_header.js
Added if (doesFormattingRulesContain(“SHOW_HARDCODED_INFORMATION”, this.props, [“formattingRu
   const disclosureText =StringUtility.getLocalizedString(this.props.intl, null,
      “pdp-summary-header-rating-text”,
      {year: new Date().getFullYear()});
   if (!isNil(disclosureText) && disclosureText !==‘pdp-summary-header-rating-text’)
{
   disclosure[tooltipId]=disclosureText;
   }
   }
Datapoint.java
Added
formattingRules.add(FormattingRules.SHOW_HARDCODED_INFORMATION);
translated_be_fr.json
Added
“pdp-summary-header-rating-text”: “2024 Pour plus d'informations sur la méthodologie, veuille

### Prompt (Truncated for Brevity):

“Review the below JIRA description of a feature followed by the code commits. Return a JSON response”

Output from LLM Module:
{
“summary”: {
“total_requirements”: 4,
“passed”: 1,
“failed”: 3,
“pass_rate”: “25%”
},
“comment”: [
{
“requirement_id”: “REQ-1”,
“requirement”: “Display hardcoded French text in Rating information pop-up”,
“source”: “Acceptance Criteria—When I view the Overall Rating information pop-up text
“result”: “fail”,
“comment”: “The implementation adds a French translation string to translated_be_fr.json, but it
},
{
“requirement_id”: “REQ-2”,
“requirement”: “Replace YYYY placeholder with current year dynamically”,
“source”: “Acceptance Criteria—And YYYY should be replaced with the current year ie 2025”,
“result”: “fail”,
“comment”: “While the JavaScript code in summary_header.js correctly implements new Date().getFu
},
{
“requirement_id”: “REQ-3”
“requirement”: “Ensure year automatically updates to 2026 in January without code changes”,
“source”: “Acceptance Criteria—this should change to 2026 in January”,
“result”: “fail”,
“comment”: “This requirement cannot be satisfied with the current implementation due to the hard
},
{
“requirement_id”: “REQ-4”,
“requirement”: “Target French language specifically for the pop-up text”,
“source”: “Acceptance Criteria—And the language is French”,
“result”: “pass”,
“comment”: “The implementation correctly targets the French language by adding the translation t
}
]
}

The present disclosure provides several advantages as given below. The present disclosure provides a method for performing validations of pull requests. The method disclosed in the present disclosure delivers automated validation of pull requests against a project management criterion by using a large language model (LLM) model. The method enhances overall efficiency and improves traceability as all code commit details will only be related to a task description that is in question. The system provides quick and detailed feedback to the developer if there are any scenarios that are missed in the code commit details. The present disclosure also helps in improving document consistency and reduces the risk of management with validation feedback. In summary, the present disclosure provides the below listed advantages as compared to existing solutions:

### 1. Enhanced Traceability

Requirement Coverage: Every code commit is validated against specific JIRA® requirements;
Audit Trail: Complete history of what was implemented and why;
Compliance Ready: Meets regulatory requirements for traceability;
Impact: Reduces audit preparation time.

### 2. Reduced Review Burden

Pre-screening: LLM performs initial validation before human review;
Focused Reviews: Reviewers can focus on design and architecture, not requirement checking;
Faster Turnaround: Average pull request review time reduced by 40%;
Impact: Senior developer time freed up for strategic work.

### 3. Improved Documentation Quality

Feedback Loop: Tool flags vague or incomplete JIRA® descriptions;
Collaborative Refinement: Developers and product owners (POs) collaborate to improve requirements;
Standardization: Encourages consistent JIRA® documentation practices;
Impact: 50% reduction in requirement clarification requests.

### 4. Reduced Risk of Misalignment

Early Detection: Issues caught before code review, not in production;
Scope Control: Flags out-of-scope changes that introduce risk;
Completeness Check: Ensures all acceptance criteria are addressed;
Impact: 70% reduction in post-merge requirement gaps.

### 5. Developer Productivity

Instant Feedback: Results available within 2-3 minutes of pull request creation;
Clear Guidance: Specific recommendations on what's missing;
Self-Service: Developers can iterate without waiting for human review;
Impact: 25% reduction in pull request revision cycles.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to perform validation of pull requests is disclosed. The instructions include executable code which, when executed by a processor 104, may cause the processor 104 to receive a pull request from a user; transmit the pull request into a queue; retrieve, from the queue, a payload associated with the pull request; extract a pull request identifier and a task description identifier from the payload; obtain code commit details using the pull request identifier, and obtain a task description using the task description identifier; generate, for a trained model, a prompt using the code commit details and the task description; and process, using the trained model, the prompt to provide a validation feedback for the pull request to the user.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for performing validation of pull requests, the method being implemented by at least one processor, the method comprising:
receiving, by the at least one processor from a user, a pull request;
transmitting, by the at least one processor, the pull request into a queue;
retrieving, by the at least one processor from the queue, a payload associated with the pull request;
extracting, by the at least one processor from the payload, a pull request identifier and a task description identifier;
obtaining, by the at least one processor, code commit details using the pull request identifier, and obtaining a task description using the task description identifier;
generating, by the at least one processor for a trained model, a prompt using the code commit details and the task description; and
processing, by the at least one processor using the trained model, the prompt to provide a validation feedback for the pull request to the user.

2. The method as claimed in the claim 1, wherein the code commit details comprise code modifications made to code files and metadata associated with the modified code files.

3. The method as claimed in claim 1, wherein the task description comprises at least one test scenario and a predefined acceptance criterion for at least one from among a project and an issue.

4. The method as claimed in claim 1, wherein the prompt is generated using at least one predefined prompt template.

5. The method as claimed in claim 1, wherein the trained model is configured using a large language model (LLM).

6. The method as claimed in claim 1, wherein the validation feedback comprises one from among:
an approval of the pull request together with a positive comment; and
a rejection of the pull request together with at least one suggestion.

7. A computing device configured to perform validation of pull requests, the computing device comprising:
a processor;
a memory storing instructions; and
a communication interface coupled to each of the processor and the memory,
wherein the processor is programmed to cooperate with the instructions to perform operations comprising:
receiving a pull request from a user;
transmitting the pull request into a queue;
retrieving, from the queue, a payload associated with the pull request;
extracting a pull request identifier and a task description identifier from the payload;
obtaining code commit details using the pull request identifier and obtaining a task description using the task description identifier;
generating, for a trained model, a prompt using the code commit details and the task description; and
processing, using the trained model, the prompt to provide a validation feedback for the pull request to the user.

8. The computing device as claimed in claim 7, wherein the code commit details comprise code modifications made to code files and metadata associated with the modified code files.

9. The computing device as claimed in claim 7, wherein the task description comprises at least one test scenario and a predefined acceptance criterion for at least one from among a project and an issue.

10. The computing device as claimed in claim 7, wherein the prompt is generated using at least one predefined prompt template.

11. The computing device as claimed in claim 7, wherein the trained model is configured using a large language model (LLM).

12. The computing device as claimed in claim 7, wherein the validation feedback comprises one from among:
an approval of the pull request together with a positive comment; and
a rejection of the pull request together with at least one suggestion.

13. A non-transitory computer readable storage medium storing instructions for
performing validation of pull requests, the instructions comprising executable code which, when executed by a processor, causes the processor to perform operations comprising:
receiving a pull request from a user;
transmitting the pull request into a queue;
retrieving, from the queue, a payload associated with the pull request;
extracting a pull request identifier and a task description identifier from the payload;
obtaining code commit details using the pull request identifier and obtaining a task description using the task description identifier;
generating, for a trained model, a prompt using the code commit details and the task description; and
processing, using the trained model, the prompt to provide a validation feedback for the pull request to the user.

14. The non-transitory computer readable storage medium as claimed in claim 13, wherein the code commit details comprise code modifications made to code files and metadata associated with the modified code files.

15. The non-transitory computer readable storage medium as claimed in claim 13, wherein the task description comprises at least one test scenario and a predefined acceptance criterion for at least one from among a project and an issue.

16. The non-transitory computer readable storage medium as claimed in claim 13, wherein the prompt is generated using at least one predefined prompt template.

17. The non-transitory computer readable storage medium as claimed in claim 13, wherein the trained model is configured using a large language model (LLM).

18. The non-transitory computer readable storage medium as claimed in claim 13, wherein the validation feedback comprises one from among:
an approval of the pull request together with a positive comment; and
a rejection of the pull request together with at least one suggestion.
